(19) United States
(12) Patent Application Publication
(10) Pub. No.: US 2012/0105733 A1
(43) Pub. Date: May 3, 2012

(54) DISPLAY APPARATUS RECEIVING BROADCASTING SIGNAL THROUGH NETWORK AND BROADCASTING RECEIVING METHOD THEREOF

(75) Inventors: Joon-hyuk RYU, Hwaseong-si (KR); Hee-yong YOUN, Suwon-si (KR)

(73) Assignee: SAMSUNG ELECTRONICS CO., LTD., Suwon-si (KR)

(21) Appl. No.: 13/168,118

(22) Filed: Jun. 24, 2011

(30) Foreign Application Priority Data
Oct. 27, 2010 (KR) 10-2010-0105028

(51) Int. Cl. H04N 5/50

(52) U.S. Cl. 348/731; 348/E05.097

(57) ABSTRACT

A display apparatus and a broadcasting receiving method thereof are provided. The display apparatus which receives a broadcasting signal from an external server through a network, the display apparatus including: a communication unit which receives channel information and channel data from a plurality of broadcasting signals; a display unit; a signal processor which processes the channel information and the channel data; and a controller which controls the signal processor to display the channel information on the display unit in a preset arrangement, requests channel data of a selected channel and candidate channels adjacent to the selected channel in at least two preset directions if the channel is selected by a user, and receives the channel data of the selected channel and the candidate channels from the server.

### CROSS-REFERENCE TO RELATED APPLICATION

This application claims priority from Korean Patent Application No. 10-2010-0105028, filed on Oct. 27, 2010 in the Korean Intellectual Property Office, the disclosure of which is incorporated herein by reference.

### BACKGROUND

1. Field

Apparatuses and methods consistent with the exemplary embodiments relate to a display apparatus receiving a broadcasting signal through a network and a broadcasting receiving method thereof, and more particularly, to a display apparatus which receives a broadcasting signal through a network displaying a plurality of channel information as a graphic and a broadcasting receiving method thereof.

2. Description of the Related Art

An Internet protocol television (IPTV) is a new service which provides digital image service, two-way data service and other various customized services by using a high-speed broadband network.

If a user changes a channel from the IPTV, a changed channel is streamed after leaving a multicast of a viewing channel and joining a multicast group of the changed channel. The time for the above process is called a channel zapping time, which takes approximately 0.5 to 2 seconds.

If a TV or a set-top box which downloads a channel stream has superior downloading capability and uses a wide network bandwidth, many channels may be downloaded simultaneously. If there are many downloadable channels, the possibility that channels to be selected by a user are included in the downloaded channels increases and this is advantageous for zapping channels. As downloading capability of the TV and bandwidth are limited in reality, zapping channels accurately and promptly in these limited circumstances is required.

### SUMMARY

Accordingly, one or more exemplary embodiments provide a display apparatus and a broadcasting receiving method thereof which reduces a channel zapping time when a broadcasting signal is received through a network.

Another exemplary embodiment provides a display apparatus and a broadcasting receiving method thereof which sets candidate channels to be downloaded corresponding to a user input unit when a broadcasting signal is received through a network.

The foregoing and/or other aspects may be achieved by providing a display apparatus which receives a broadcasting signal from an external server through a network, the display apparatus including: a communication unit which receives channel information and channel data of a plurality of broadcasting signals; a display unit; a signal processor which processes the channel information and the channel data; and a controller which controls the signal processor to display the channel information on the display unit in a preset arrangement, requests channel data of a selected channel and candidate channels adjacent to the selected channel in at least two preset directions if the channel is selected by a user, and receives the channel data of the selected channel and the candidate channels from the server.

The signal processor may display the channel information on the display unit in matrix form, and the controller may request the channel data of first candidate channels surrounding the selected channel in up, down, left and right directions.

The controller may request channel data of second candidate channels surrounding the first candidate channels.

The display apparatus may further include a user input unit which includes a direction button to move a focus to up, down, left and right directions, and the signal processor may display the channel information on the display unit in matrix form, and the controller may request the channel data of the first candidate channels arranged in a direction corresponding to a direction button from the selected channel if a hold signal is input by holding one of the directions buttons for a predetermined time or more.

The controller may request the channel data of the second candidate channels arranged in up and down or left and right directions of the first candidate channels.

The display apparatus may further include a user input unit which includes a direction button to move a focus in up, down, left and right directions, and the controller may control the signal processor to display the received channel data on the display unit if one of the candidate channels is selected by the direction button.

The channel information may include thumb nail information of the channel.

The foregoing and/or other aspects may be achieved by providing a broadcasting receiving method of a display apparatus which receives a broadcasting signal from an external server through a network and includes a display unit, the method including: receiving channel information of a plurality of broadcasting signals; displaying the channel information on the display unit in a preset arrangement; receiving a selection signal from a user to select a channel; requesting channel data of the selected channel and candidate channels adjacent to the selected channel in at least two preset directions; and receiving the channel data of the selected channel and the candidate channels from the server.

The method may further include processing and displaying on the display unit received channel data if one of the candidate channels is selected.

The channel information may be displayed on the display unit in matrix form, and the requesting the channel data to the server may include requesting channel data of first candidate channels which surround the selected channel in up, down, left and right directions.

The method may further include requesting channel data of second candidate channels surrounding the first candidate channels.

The method may further include: receiving a hold signal generated when a particular direction button is held for a predetermined time or more, and the channel information may be displayed on the display unit in matrix form, and the requesting the channel data to the server may include requesting the channel data of the first candidate channels arranged in a direction corresponding to the direction button from the selected channel.

The method may further include requesting channel data of second candidate channels arranged in up and down or left and right directions of the first candidate channels.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a control block diagram of a display apparatus according to an exemplary embodiment;

FIG. 2 illustrates channel information which is displayed in the display apparatus according to an exemplary embodiment;

FIG. 3 illustrates channel information of the first candidate channels according to an exemplary embodiment;

FIG. 4 illustrates channel information of the second candidate channels according to an exemplary embodiment;

FIG. 5 is a control flowchart of a broadcasting receiving method of the display apparatus according to an exemplary embodiment;

FIG. 6 illustrates channel information which is displayed in the display apparatus according to another exemplary embodiment;

FIG. 7 illustrates channel information of the candidate channels according to another exemplary embodiment; and

FIG. 8 is a control flowchart of a broadcasting receiving method of a display apparatus according to another exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

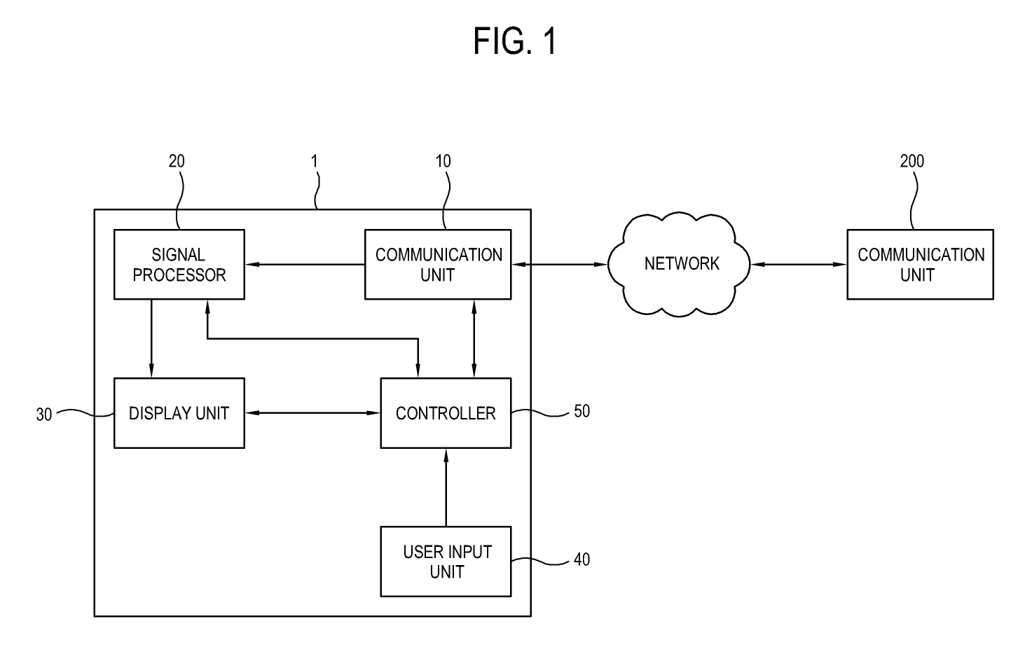

FIG. 1 is a control block diagram of a display apparatus according to an exemplary embodiment.

As shown therein, a display apparatus 1 communicates with a server 200 through a network and receives a broadcasting signal from the server 200. The display apparatus 1 may include an Internet protocol television (IPTV) which provides digital image service, two-way data service and other various customized services through a high-speed broadband network, a computer system which includes a display unit such as a monitor or a screen, or a personal portable terminal such as netbook, an e-book and a smart phone including a web-browsing function. Hereinafter, the display apparatus 1 according to an exemplary embodiment includes an IPTV as an example. The display apparatus 1 includes an IPTV integrating a set-top box. The display apparatus 1 includes a communication unit 10, a signal processor 20, a display unit 30, a user input unit 40, and a controller 50 which controls the communication unit 10 and the signal processor 20 to receive a broadcasting signal.

The communication unit 10 receives channel information and channel data for a channel of a broadcasting signal from the server 200 through a network. The channel information and the channel data may be received from the same or different servers. The channel information may include graphic user interface (GUI) information such as a thumb nail of a channel. The channel information may be transmitted as meta data or a hyper text markup language (HTML) and java script through the communication unit 10. The channel data represents data corresponding to a broadcasting signal, and transmitted as streaming data instead of being broadcast. If the broadcasting signal is received by channel streaming, the display apparatus 1 may receive broadcasting signals of many channels simultaneously as long as the display apparatus 1 has superior downloading capability and uses a wide network bandwidth. If the number of downloadable channels increases, the possibility that the selectable channels are included in the downloaded channels becomes high, which is advantageous for zapping channels. If a user selects or changes a channel, processes of leaving a multicast of a previous channel and of joining a multicast of a new channel are performed, and channel data, i.e., a multicast traffic is transmitted to the display apparatus 1. The time during which the network communication is performed, the received channel data is buffered, decoded and displayed after a user changes the channel is called channel zapping time. Therefore, due to these processes, the channel zapping time is a major factor for delayed channel change in the IPTV.

The signal processor 20 processes the channel information and the channel data to be displayed on the display unit 30. The signal processor 20 may include a web browser to display on the display unit 30 the channel information formed as a web page by HTML or java script. The image processing performed by the signal processor 20 includes demulitplexing, decoding, scaling, picture quality adjustment and picture quality improvement.

The display unit 30 displays thereon the channel information and the channel data. The display unit 30 may include a cathode ray tube (CRT), a liquid crystal display (LCD) including liquid crystal, an organic light emitting display (OLED) including an organic light emitting layer, or a plasma display panel (PDP).

The user input unit 40 is an interface for a user's input for selecting and changing a channel, and may include a remote controller which is separate from a display main body including the display unit 30. The user input unit 40 may include a up/down/left/right direction button, a numeric button, or a selection button. The user input unit 40 may further include a wheel type input unit or a touch pad. The user input unit 40 may further include a signal transmitter to transmit a remote control signal corresponding to a detected user's input, and a signal controller to control the foregoing elements.

The controller 50 controls the signal processor 20 to display on the display unit 30 the channel information as a preset arrangement, requests and receives from the server 200 channel data for the selected channel and candidate channels arranged adjacently to the selected channel in at least two preset directions.

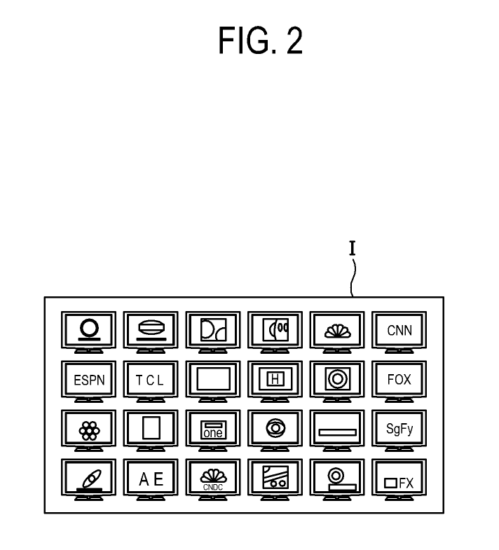

FIG. 2 illustrates channel information I displayed in the display apparatus 1 according to an exemplary embodiment. As shown therein, information on a plurality of selectable channels is displayed as a thumb nail on the display unit 30, and the channel information I is arranged in matrix form. The channel information I may include a channel number or only graphic information. The number of channels included in the channel information I may be set as a default or changed by a user. The channel information I may include all the information of currently receivable channels. The channel information I may be displayed in an area of the display unit 30 not to hide a broadcasting signal currently displayed on the display unit 30 or may be displayed horizontally or vertically along one side of the display unit 30 like a subtitle. A user may select or change a channel while viewing the channel information I. The channel information I may display received channels only or the channel information I which was received in the past but not currently received may be displayed as inactive.

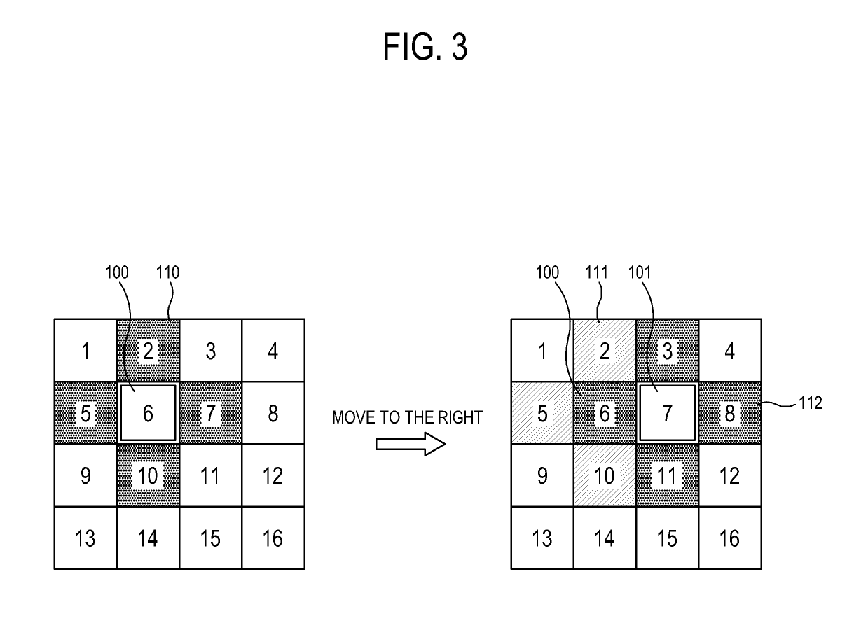

FIG. 3 illustrates channel information of the first candidate channels according to an exemplary embodiment. If a user selects a channel, the controller 50 requests and receives from the server 200, a selected channel 100 and channel data of first candidate channels 110 arranged adjacently to the selected channel 100 in up and down and left and right directions of the selected channel 100. The first candidate channels 110 include four channels surrounding the selected channel 100. If a user selects a channel no. 6, channel data of channel nos. 2, 5, 7 and 10 are received from the server 200 and buffered by the controller 50.

If a user selects one of the first candidate channels 110 by selecting a right direction button as shown therein, the controller 50 may immediately display on the display unit 30 channel data of the channel no. 7. That is, channel data of the channel no. 7 is displayed without network communication such as joining a multicast and thus channel zapping time may be reduced. If the channel no. 7 101 is selected, the controller 50 receives channel data of channel nos. 3, 6, 8 and 11 as first candidate channels 112 which are adjacent to the channel no. 7 in two directions, that is, up/down/left/right directions. If the network includes a number of home gates or many network switches such as a router, joining and leaving a multicast takes a long time and the channel zapping time increases. The controller 50 sets candidates channels which are likely to be selected by a user, receives channel data of the candidate channels in advance to thereby reduce the channel zapping time. A multicast leaving process is performed on channel nos. 2, 5 and 10 111 which are not duplicated among the first candidate channels 110 of the previous channel 100 and the first candidate channels 112 of the current channel 101. The first candidate channels may be set to surround the selected channel from all directions including a diagonal direction as well as up/down/left/right directions of the selected channel. That is, the candidate channels of the selected channel vary depending on the downloading capability of the display apparatus 1 and the bandwidth of the network.

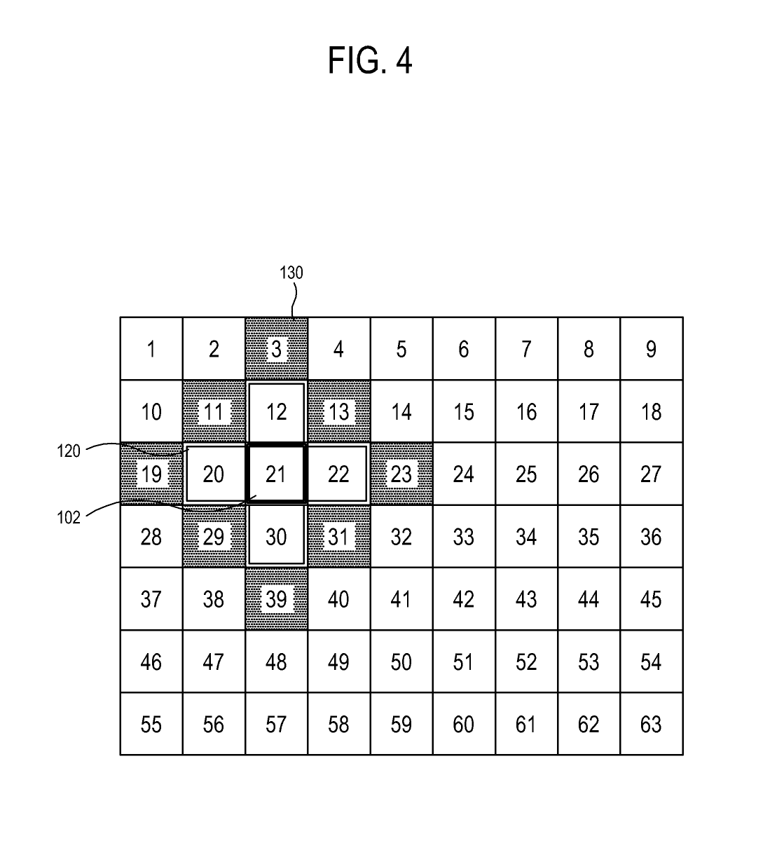

FIG. 4 illustrates channel information of the second candidate channels according to an exemplary embodiment. As shown therein, the controller 50 selects second candidate channels 130 surrounding the first candidate channels 120 in addition to the first candidate channels 120, as candidate channels of the selected channel 102. The controller 50 may request channel data of the first candidate channels 120 and the second candidate channels 130 to the server 200.

Request and reception of the channel data of the second candidate channels 130 may be selectively set depending on the downloading capability of the display apparatus 1 and the bandwidth of the network. If the environment in which the channel data is received is not good, only the channel data of the first candidate channels 120 may be received. If the reception environment of the channel data is good, third candidate channels surrounding the second candidate channels 130 or further candidate channels may also be received.

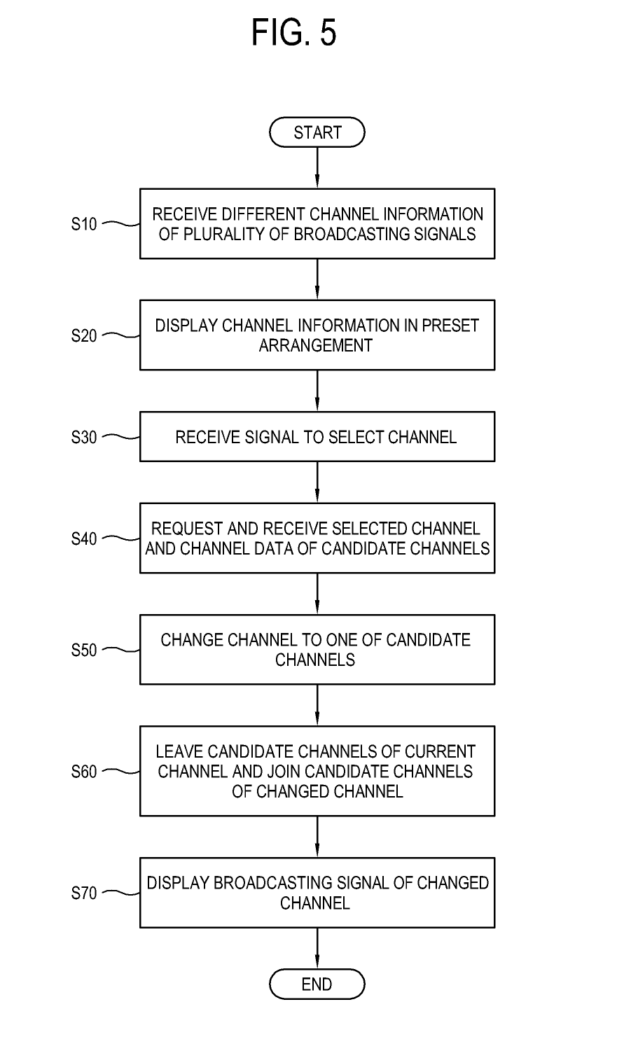

FIG. 5 is a control flowchart of a broadcasting receiving method of the display apparatus 1 according to an exemplary embodiment. The broadcasting receiving method will be described with reference to FIG. 5.

First, the channel information of a plurality of broadcasting signals is received (S10). The signal processor 20 displays on the display unit 30 the channel information I in a preset arrangement, e.g., in a matrix according to a control of the controller 50 (S20).

If the selection signal is received to select the channel (S30), the controller 50 requests the channel data of the selected channel and the candidate channels which are adjacent to the selected channel in at least two preset directions and receives the channel data of the selected channel and the candidate channels from the server 200 (S40). The candidate channels may be set as the first candidate channels surrounding the selected channel in up/down/left/right directions and the second candidate channels surrounding the first candidate channels.

The signal processor 20 processes the channel data selected by a user among the received channel data, and displays the channel data on the display unit 30.

If a user changes the channel, e.g., changes from the current channel to one of the candidate channels (S50), the controller 50 instructs the candidate channel of the current channel to leave the multicast and instructs the candidate channel of the changed channel to join the multicast (S60).

The controller 50 controls the signal processor 20 to display on the display unit 30 the broadcasting signal of the changed channel (S70).

According to another exemplary embodiment, the user input unit 40 may include a diagonal direction button instead of up/down/left/right direction buttons. In this case, the controller 50 may set the channels adjacent to the selected channel in a diagonal direction as the candidate channels and receive the channel data of the candidate channels.

The user input unit 40 may include a touch pad or a touch screen which receives instructions through a user's touch. If the touch pad or the touch screen is used instead of buttons, the candidate channels may be set based on a user's touch pattern.

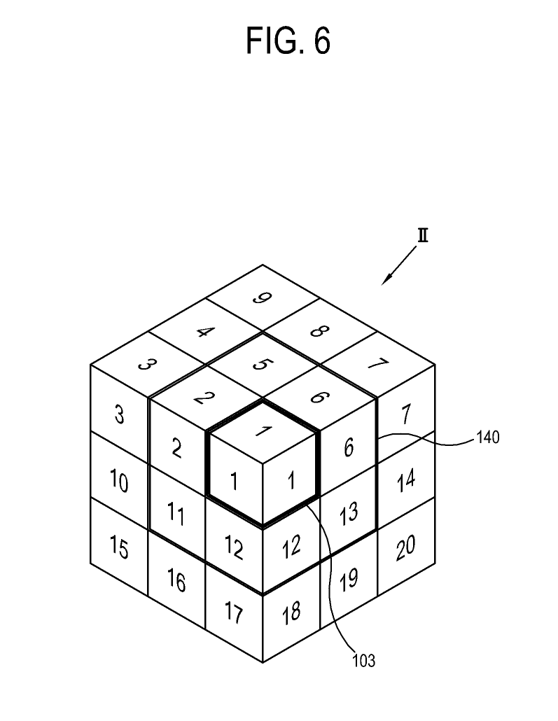

FIG. 6 illustrates channel information which is displayed in the display apparatus 1 according to another exemplary embodiment. As shown therein, channel information II is arranged not in two-dimensional but three-dimensional cubic pattern. If a channel no. 1 is a selected channel 103 in the cubic pattern, candidate channels 140 surrounding the selected channel 103 in all three-dimensional directions are selected, and the controller 50 requests channel data of the candidate channels 140. However, the patterns are not limited to a cubic pattern and may have other patterns, for example, the channel information II may be arranged in form of a three-dimensional sphere. Furthermore, a user may rotate the cubic image, and change the channel information II into a two-dimensional matrix

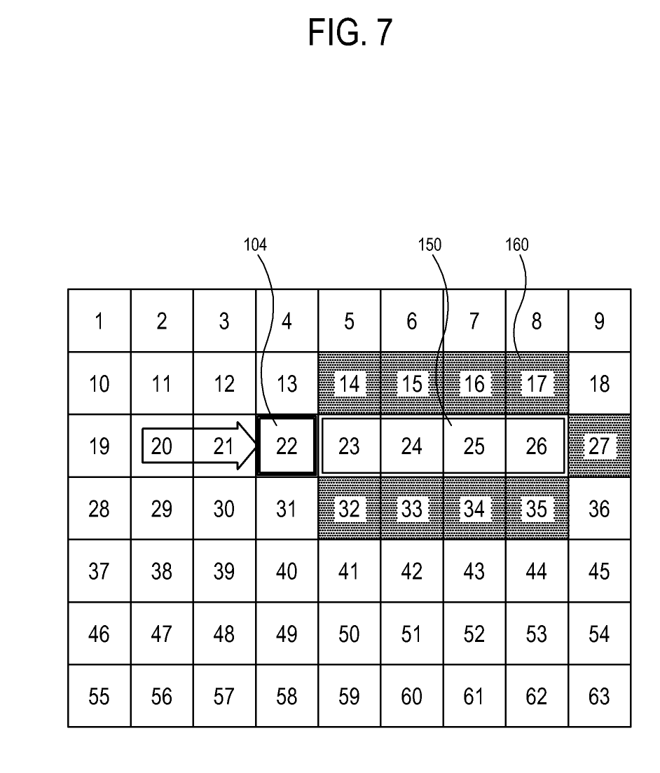

FIG. 7 illustrates channel information of candidate channels according to another exemplary embodiment.

If a hold signal is input by a user pushing one of the direction buttons for a predetermined time, the controller 50 requests channel data of candidate channels arranged in a direction corresponding to the direction button from the selected channel 104. The hold signal is generated when a user keeps pushing the direction button until a focus is given to a desired channel instead of pushing the direction button several times to select the channel arranged in a predetermined direction. Accordingly, the controller 50 requests the data of the channel located in a row or column in the direction corresponding to the direction button to select highly selectable channels as the candidate channels.

As shown therein, first candidate channels 150 are channels arranged in the same row as the selected channel 104. Additionally, channels surrounding the first candidate channels 150 in up and down directions may be set as second candidate channels 150.

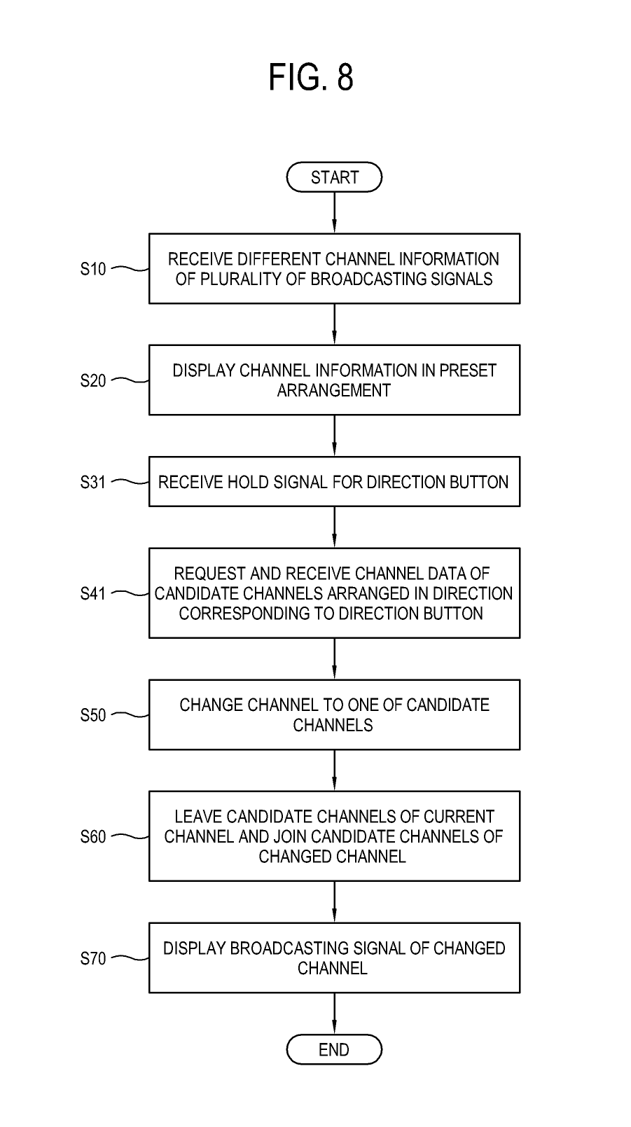

FIG. 8 is a control flowchart of a broadcasting receiving method of the display apparatus according to an exemplary embodiment. As shown therein, the broadcasting receiving method includes operations S10, S20 and S50 to S70 in FIG. 5. That is, the processes of receiving and displaying the channel data of the candidate channels upon the selection of the channel are substantially the same.

If the hold signal is generated by a user pushing the predetermined direction button for a predetermined time or more (S31), the controller 50 requests and receives from the server 200 the channel data of the candidate channels arranged in the direction corresponding to the held direction button (S41). If a user holds the right direction button, the channels in the concerned direction may be set as the first candidate channels, and the channels arranged in up and down directions of the first candidate channels may be set as the second candidate channels. If a user holds the up or down direction button, the channels in a particular column may be set as the first candidate channels, and channels arranged in the left and right directions of the first candidate channels may be set as the second candidate channels.

The present embodiments are characterized by receiving channel data of highly selectable channels in advance to reduce channel zapping time when a broadcasting signal is received through a network. The candidate channels may be set based on the direction button of the user input unit.

As described above, a display apparatus and a broadcasting receiving method thereof according to an exemplary embodiment reduces channel zapping time when a broadcasting signal is received through a network.

Also, a display apparatus and a broadcasting receiving method thereof according to another exemplary embodiment sets candidate channels to be downloaded corresponding to a user input unit when a broadcasting signal is received through a network.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A display apparatus which receives a plurality of broadcasting signals from an external server through a network, the display apparatus comprising:
a communication unit which receives channel information and channel data of the plurality of broadcasting signals;
a signal processor which processes the channel information and the channel data; and
a controller which controls the signal processor to display the channel information on a display unit in a preset arrangement, requests channel data of a selected channel and candidate channels located adjacent to the selected channel in the preset arrangement in at least two preset directions if the channel is selected by a user, and receives the channel data of the selected channel and the candidate channels from the server.

2. The display apparatus according to claim 1, wherein the signal processor displays the channel information on the display unit in matrix form, and the controller requests channel data of first candidate channels surrounding the selected channel in up, down, left and right directions.

3. The display apparatus according to claim 2, wherein the controller requests channel data of second candidate channels surrounding the first candidate channels.

4. The display apparatus according to claim 1, further comprising a user input unit which comprises a direction button to move a focus to up, down, left and right directions, wherein
the signal processor displays the channel information on the display unit in matrix form, and the controller requests channel data of first candidate channels arranged in a direction corresponding to the direction button from the selected channel if a hold signal is input by holding the direction button for a predetermined time or more.

5. The display apparatus according to claim 4, wherein the controller requests channel data of second candidate channels arranged in up and down or left and right directions of the first candidate channels.

6. The display apparatus according to claim 1, further comprising a user input unit which comprises a direction button to move a focus in up, down, left and right directions, wherein
the controller controls the signal processor to display channel data of the selected candidate channel on the display unit if one of the candidate channels is selected by the direction button.

7. The display apparatus according to claim 1, wherein the channel information comprises thumb nail information of the channel.

8. A broadcasting receiving method of a display apparatus which receives a plurality of broadcasting signals from an external server through a network and comprises a display unit, the method comprising:
receiving channel information of the plurality of broadcasting signals;
displaying the channel information on the display unit in a preset arrangement;
receiving a selection signal from a user to select a channel;
requesting channel data of the selected channel and candidate channels located adjacent to the selected channel in the preset arrangement in at least two preset directions; and
receiving the channel data of the selected channel and the candidate channels from the external server.

9. The method according to claim 8, further comprising processing and displaying on the display unit channel data of the selected candidate channel if one of the candidate channels is selected.

10. The method according to claim 8, wherein the channel information is displayed on the display unit in matrix form, and the requesting the channel data to the external server comprises requesting channel data of first candidate channels which surround the selected channel in up, down, left and right directions.

11. The method according to claim 10, further comprising requesting channel data of second candidate channels surrounding the first candidate channels.

12. The method according to claim 8, further comprising: receiving a hold signal generated when a particular direction button is held for a predetermined time or more,
wherein the channel information is displayed on the display unit in matrix form, and the requesting the channel data to the external server comprises requesting the channel data of the first candidate channels arranged in a direction corresponding to the direction button from the selected channel.

13. The method according to claim 12, further comprising requesting channel data of second candidate channels arranged in up and down or left and right directions of the first candidate channels.

14. The method according to claim 8, wherein the channel information is displayed in an area of the display unit so as not to hide one of the plurality of broadcasting signals currently displayed on the display unit.

15. The method according to claim 8, wherein the channel information is displayed in an area of the display unit in a horizontal or vertical direction.

16. The display apparatus according to claim 4, wherein the user input unit comprises a remote controller including a signal transmitter to transmit a remote control signal corresponding to an input, and a signal controller to control the display apparatus.

17. A display apparatus which receives a plurality of broadcasting signals from a server through a network, the display apparatus comprising:
a communication unit which receives channel information and channel data of a plurality of selectable channels from the plurality of broadcasting signals;
a signal processor which processes the channel information and the channel data of the plurality of selectable channels; and
a controller which selects a channel from the plurality of selectable channels, and requests from the server the channel data of the selected channel and the channel data of the plurality of selectable channels, and which receives the data of the selected channel and the data of the plurality of selectable channels, and which displays the selected channel and the channel information of the plurality of selectable channels in a present pattern on a display unit.

18. The display apparatus according to claim 17, wherein the present pattern is in matrix form, and the plurality of selectable channels are displayed in a pattern surrounding the selected channel.

19. The display apparatus according to claim 18, wherein the plurality of selectable channels includes first candidate channels which are disposed adjacent to the selected channel in up, down, left and right directions.
